(19) United States
(12) Patent Application Publication
(10) Pub. No.: US 2026/0266686 A1
(43) Pub. Date: Sep. 10, 2026

(54) LASER ABSORPTION AND SCATTERED LIGHT METROLOGY TOOL

(71) Applicant: Applied Materials, Inc., Santa Clara, CA (US)

(72) Inventors: Michael David-Scott KEMP, San Jose, CA (US); Baochen WU, Santa Clara, CA (US); Jinxin FU, Fremont, CA (US); Zhengping YAO, Cupertino, CA (US)

(21) Appl. No.: 19/164,069

(22) PCT Filed: Feb. 27, 2024
(86) PCT No.: PCT/US2024/017502

§ 371 Date: Sep. 10, 2025

Related U.S. Application Data
(60) Provisional application No. 63/493,251, filed on Mar. 30, 2023.

(51) Int. Cl. G01M 11/00

(52) U.S. Cl. CPC G01M 11/31; G01M 11/33

(57) ABSTRACT

Embodiments described herein relate to an optical device metrology system including a light source operable to emit a light into a first photodetector light path and an optical light path. A first photodetector disposed in the first photodetector light path measures a total power of the light. The optical device substrate disposed in the optical light path splits the light in a plurality of light paths. A second photodetector in a second photodetector light path measures a reflected power of the light. A third photodetector in a third photodetector light path measures a transmitted power of the light. A fourth photodetector disposed in a fourth photodetector light path and a fifth photodetector disposed in a fifth photodetector light path measure a total scattered power. A controller is operable to receive a plurality of measurements from the photodetectors to calculate a percentage light loss within the optical device substrate.

### BACKGROUND

### Field

Embodiments of the present disclosure generally relate to optical devices. More specifically, embodiments described herein relate to a measurement system and a method to measure percentage light loss of at least one of an optical film, optical device, or an optical device substrate.

### Description of the Related Art

Optical devices including waveguide combiners, such as augmented reality waveguide combiners, and flat optical devices, such as metasurfaces, are used to assist in overlaying images. Generated light is propagated through the optical device until the light exits the optical device and is overlaid on the ambient environment.

Fabricated optical devices tend to lose light through absorption or scattering as the light is propagated through the optical device or optical device substrate. The optical devices are fabricated from optical device substrates, and in some instances optical films, e.g., when an optical device is fabricated from an optical film disposed on an optical device substrate. It is beneficial to measure the percentage light loss from the optical film and the optical device substrate prior to, during, and after fabricating the optical device.

Therefore, what is needed in the art is a measurement system and a method to measure percentage light loss of at least one of an optical film, an optical device, or an optical device substrate.

### SUMMARY

In one embodiment, an optical device metrology system includes a light source operable to emit a light into a first photodetector light path and an optical light path. A first photodetector disposed in the first photodetector light path is operable to measure a total power of the light. A second photodetector is disposed in a second photodetector light path from an optical device substrate. The optical device substrate is disposed in the optical light path and operable to split the light into the second photodetector light path, a third photodetector light path, a fourth photodetector light path, and a fifth photodetector light path. The second photodetector operable to measure a reflected power of the light. The third photodetector disposed in the third photodetector light path, the third photodetector operable to measure a transmitted power of the light. The fourth photodetector disposed in a fourth photodetector light path. The fourth photodetector operable to measure a first portion of a scattered power of the light. A fifth photodetector is disposed in a fifth photodetector light path. The fifth photodetector is operable to measure a second portion of the scattered power of the light. A controller is operable to receive a plurality of measurements from the first photodetector, second photodetector, third photodetector, fourth photodetector, and fifth photodetector to calculate a percentage light loss within the optical device substrate.

In another embodiment, a method includes projecting a light from a light source toward a first photodetector in a first photodetector light path and an optical device substrate in an optical light path; measuring a total power of the light in the first photodetector light path at the first photodetector; projecting the light to the optical device substrate in the optical light path; splitting the light into a second photodetector light path, a third photodetector light path, a fourth photodetector light path, and a fifth photodetector light path at the optical device substrate; projecting the light to a second photodetector in the second photodetector light path; measuring a reflected power of the light in the second photodetector light path at the second photodetector; projecting the light to a third photodetector in the third photodetector light path; measuring a transmitted power of the light in the third photodetector light path at the third photodetector; projecting the light to a fourth photodetector in the fourth photodetector light path; measuring a first portion of a scattered power of the light in the fourth photodetector light path at the fourth photodetector; projecting the light to a fifth photodetector in the fifth photodetector light path; measuring a second portion of the scattered power of the light in the fifth photodetector light path at the fifth photodetector; collecting a plurality of measurements from the first photodetector, second photodetector, third photodetector, fourth photodetector, and fifth photodetector at a controller; and calculating a percentage light loss at a controller, the percentage light loss due to scattering, and the percentage light loss due to absorption at the optical device substrate using the plurality of measurements. A total scattered power is comprised of the first portion of scattered power and second portion of scattered power. The plurality of measurements comprises the total power, the reflected power, the transmitted power, and the total scattered power.

In yet another embodiment, a controller is disclosed. The controller of a metrology system stores instructions that, when executed by a processor, cause the metrology system to measure the percentage light loss of an optical device disposed in the metrology system. The measurement of the percentage light loss comprises projecting a light from a light source toward a first photodetector in a first photodetector light path and an optical device substrate in an optical light path. A total power of the light in the first photodetector light path is measured at the first photodetector. The light is projected to the optical device substrate in the optical light path. The light is split into a second photodetector light path, a third photodetector light path, a fourth photodetector light path, and a fifth photodetector light path at the optical device substrate. The light is projected to a second photodetector in the second photodetector light path, a third photodetector in the third photodetector light path, a fourth photodetector in the fourth photodetector light path, and a fifth photodetector in the fifth photodetector light path. A reflected power of the light is measured at the second photodetector. A transmitted power of the light is measured at the third photodetector. A first portion of a scattered power of the light is measured at the fourth photodetector. A second portion of the scattered power of the light is measured at the fifth photodetector. A total scattered power is comprised of the first portion of scattered power and second portion of scattered power. A plurality of measurements is collected from the first photodetector, second photodetector, third photodetector, fourth photodetector, and fifth photodetector at a controller. A percentage light loss is calculated at a controller.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and may admit to other equally effective embodiments.

FIG. 1 is a perspective, frontal view of an optical device substrate according to embodiments described herein.

FIG. 2A is a schematic cross-sectional side view of an optical device metrology system according to embodiments described herein.

FIG. 2B is a schematic perspective view of an optical device metrology system according to embodiments described herein.

FIG. 3 is a schematic diagram of a controller according to embodiments described herein.

FIG. 4 is a flow diagram of a method of determining the percentage light loss according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to optical devices. More specifically, embodiments described herein relate to an optical device metrology system for measuring the light lost in optical films, optical devices, and transparent optical device substrates.

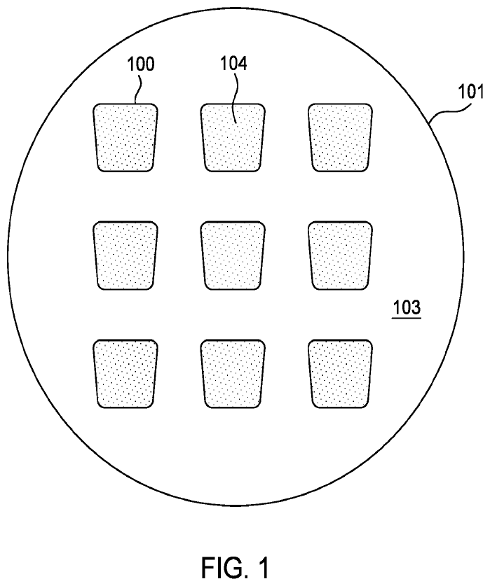

FIG. 1 is a perspective, frontal view of an optical device substrate 101 according to embodiments described herein. In some embodiments, the optical device substrate 101 includes a plurality of optical devices 100 disposed on a surface 103 of the optical device substrate 101. The optical devices 100 may be waveguide combiners utilized for virtual, augmented, or mixed reality. In some embodiments, which can be combined with other embodiments described herein, the optical devices 100 are flat optical devices, such as metasurfaces.

The optical device substrate 101 can be any optical device substrate used in the art, depending on the use of the optical device substrate 101. Additionally, the optical device substrate 101 may be of varying shapes, thicknesses, and diameters. For example, the optical device substrate 101 may have a diameter of about 150 mm to about 300 mm. The optical device substrate 101 may have a circular, rectangular, or square shape. The optical device substrate 101 may have a thickness of between about 300 μm to about 1 mm. Although only nine optical devices 100 are shown on the optical device substrate 101, any number of optical devices 100 may be disposed on the surface 103. An optical film 104 may be disposed on the optical device 100. The optical device metrology system 200 and the method 400 described herein are utilized to measure the percentage light loss of the optical film 104, optical device substrates 101, and optical devices 100 described herein.

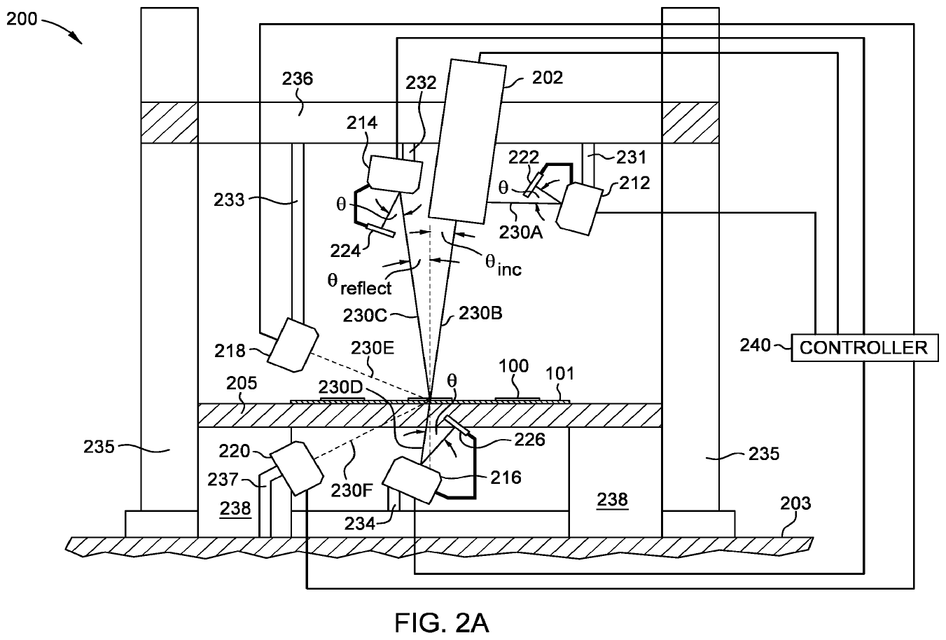

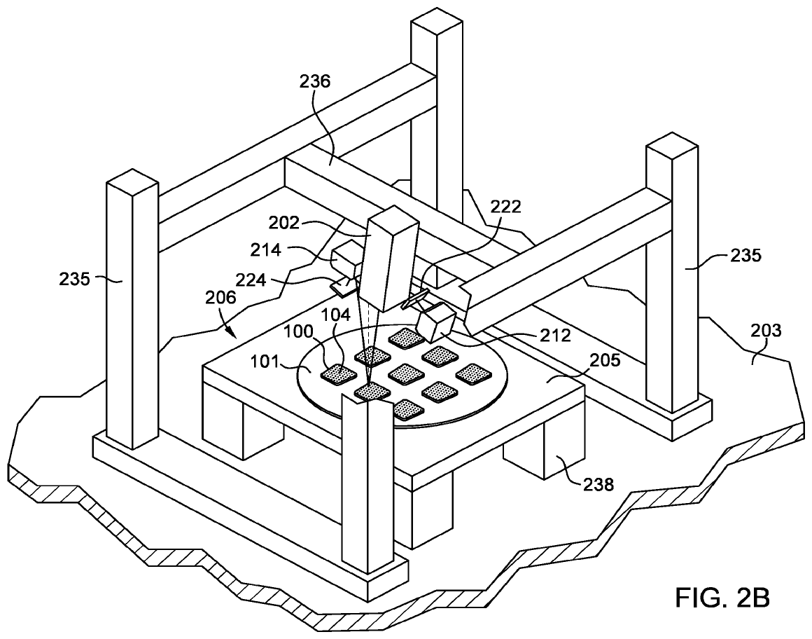

FIG. 2A is a schematic cross-sectional side view of an optical device metrology system 200. FIG. 2B is a schematic perspective view of an optical device metrology system 200. The optical device metrology system 200 is operable to measure the amount of light lost (e.g., absorbed) by an optical device substrate 101, an optical film 104 disposed on the optical device substrate 101, or an optical device 100. The optical device metrology system 200 is operable to quantify the percentage of light lost through absorption into the optical device substrate 101, an optical film 104 disposed on the optical device substrate 101, or an optical device 100. The optical device metrology system is operable to quantify the percentage of light lost through scattering off the optical device substrate 101, an optical film 104 disposed on the optical device substrate 101, or an optical device 100. The optical device substrate 101, optical device 100, or optical film 104 of the optical device substrate 101 may be measured at one or more stages of manufacturing.

The optical device metrology system 200 includes light source 202, a first photodetector 212, a second photodetector 214, a third photodetector 216, a fourth photodetector 218, and a fifth photodetector 220. A first knife edge 222 is coupled to and spaced apart from the first photodetector 212. A second knife edge 224 is coupled to and spaced apart from the second photodetector 214. A third knife edge 226 is coupled to and spaced apart from the third photodetector 216. The first knife edge 222, the second knife edge 224, and the third knife edge 226 are operable to absorb any light that reflects off of the first photodetector 212, the second photodetector 214, and the third photodetector 216, respectively. By absorbing the light that reflects off the first photodetector 212, the second photodetector 214, and the third photodetector 216, the first knife edge 222, the second knife edge 224, and the third knife edge 226, respectively, remove noise from the optical device metrology system 200. The first knife edge 222, the second knife edge 224, and the third knife edge 226 are positioned at an angle θ from the first photodetector 212, the second photodetector 214, and the third photodetector 216, respectively. The angle θ may be about 3° to about 9°, such as about 6°, though other angles are contemplated by this disclosure. The light source 202, first photodetector 212, second photodetector 214, third photodetector 216, fourth photodetector 218, and fifth photodetector 220 are in communication with a controller 240.

The optical device metrology system 200 is operable to support the optical device substrate 101. The optical device substrate 101 may include at least one optical device 100 disposed on the optical device substrate 101. In some embodiments, the optical device substrate 101 includes an optical film 104 disposed thereon. In some embodiments, the optical device substrate 101 may be disposed on a substrate support 205 (e.g., an edge ring or other transparent substrate support) to support the optical device substrate 101 in the optical device metrology system 200.

The system 200 includes a system base 203. A support structure 235 is coupled to the system base 203. A support beam 236 is coupled to the support structure 235. The light source 202, first photodetector 212, second photodetector 214, and fourth photodetector 218 are coupled to the support beam 236. The support beam 236 supports the light source 202, first photodetector 212, second photodetector 214, and fourth photodetector 218. The light source may be coupled to the support beam 236 via a connection beam (not shown). The first photodetector 212 may be connected to the support beam 236 via connection beam 231. The second photodetector 214 may be connected to the support beam 236 via connection beam 232. The fourth photodetector 218 may be connected to the support beam 236 via connection beam 233.

Substrate support 205 is coupled to a pedestal 206. The pedestal 206 may include one or more supports 238. The supports 238 are coupled to the system base 203. The substrate support 205 is moveable in one or more directions. In one embodiment, the substrate support 205 is moveable via one or more actuators. The substrate support 205 may be operable to move the optical device substrate 101 to one or more measurement positions, e.g., up to 90 predetermined measurement positions, such as up to about 15 predetermined measurement positions, such as up to 9 predetermined measurement positions.

The system base 203 supports the third photodetector 216 and the fifth photodetector 220. The third photodetector 216 may be connected to the system base 203 via connection beam 234. The fifth photodetector 220 may be connected to the system base 203 via connection beam 237.

The light source 202 is operable to emit a light in a first photodetector light path 230A and an optical light path 230B. A pre-alignment camera may be used to align the light source 202 with the optical device substrate 101. The first photodetector light path 230A is directed toward the first photodetector 212. The first photodetector 212 is operable to measure a total power (Pₜₒₜ) of the light emitted from the light source 202. The optical light path 230B is directed toward the optical device substrate 101. The light source 202 is positioned at an incidence angle θ_{inc} to the optical device substrate 101. The θ_{inc} is maintained so that the optical path length inside the optical device substrate 101 stays unchanged as different types of light are emitted from the light source 202. The incident angle may be about 6°±0.5°, although other angles are contemplated by this disclosure. In one embodiment, which can be combined with other embodiments described herein, the light source 202 is a light-emitting diode (LED). In another embodiment, the light source is a laser, such as a red/green/blue (RGB) laser. The RGB laser can alternately or simultaneously emit a combination of blue light having a wavelength of about 473 nm, green light having a wavelength of about 520 nm, and red light having a wavelength of about 642 nm.

The optical device substrate 101 is operable to split the light following the optical light path 230B into a plurality of photodetector light paths. The optical device substrate 101 splits the light based on the optical device substrate's 101 or optical film's 104 physical properties, such as transmission coefficient or reflection coefficient. The plurality of photodetector light paths include a second photodetector light path 230C, a third photodetector light path 230D, a fourth photodetector light path 230E, and a fifth photodetector light path 230F. The second photodetector light path 230C is directed toward the second photodetector 214. The light that reflects off the optical device substrate 101 travels along the second photodetector light path 230B. The second photodetector 214 is operable to measure a reflected power (P_{refl}) of the light emitted from the light source 202. The second photodetector 214 is positioned at a refraction angle θ_{refract} relative to the optical light path 230B.

The third photodetector light path 230D is directed toward the third photodetector 216. The light that transmits through the optical device substrate 101 travels along the third photodetector light path 230C. The third photodetector 216 is operable to measure a transmitted power (Pₜᵣₐₙₛ) of the light emitted from the light source 202. The fourth photodetector light path 230E is directed towards the fourth photodetector 218. A first portion of light that scatters off the optical device substrate 101 travels along the fourth photodetector light path 230E. The fourth photodetector 218 is operable to measure a first portion of scattered power (P_{scat1}) of the light emitted from the light source 202. A second portion of light that scatters off the optical device substrate 101 travels along the fifth photodetector light path 230F. The fifth photodetector 220 is operable to measure a second portion of scattered power (P_{scat2}) of the light emitted from the light source 202. The first portion of scattered power P_{scat1} and the second portion of scattered power P_{scat2} are combined to calculate the total scattered power P_{scat}. In some embodiments, more than two photodetectors may be used to calculate the total scattered power P_{scat}.

The use of the plurality of photodetectors captures measurements of the power of the projected light at 5 detection points. By capturing the total scattered power P_{scat}, the optical device metrology system 200 can quantify the percentage of light loss that is attributed to scattering and the percentage of light loss that is attributed to absorption. The substrate support 205 moves the optical device substrate 101 to gather measurements across the surface of the optical device substrate 101 in order to determine an average light loss (and, subsequently, quantifying the percentage of scattered light and absorbed light) across the optical device substrate 101, further improving the quality of the optical device substrate 101. Each measurement across the surface of the optical device substrate 101 may take less than about 1 second, increasing the throughput of the optical device metrology system 200.

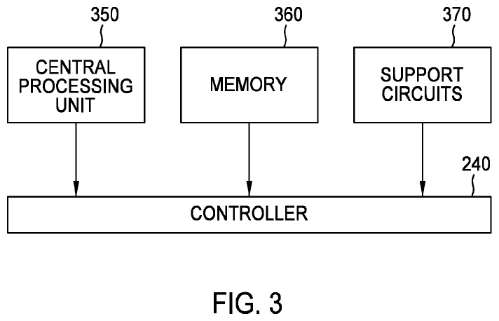

FIG. 3 illustrates the controller 240 of the optical device metrology system 200. The optical device metrology system 200 is in communication with the controller 240. The controller 240 facilitates the control and automation of the method 400 for measuring percentage light loss of the optical device substrates 101 described herein. The controller 240 may include a central processing unit (CPU) 350, a memory 360, and support circuits 370. The CPU 350 may be one of any form of computer processors that are used in industrial settings for controlling various processes and hardware (e.g., motors and other hardware) and monitoring the processes (e.g., changes in the percentage light loss in an optical device substrate 101 throughout the manufacturing process). The memory 360 is connected to the CPU and may be readily available memory, such as random access memory (RAM). Software instructions and data can be coded and stored within the memory 360 for instructing the CPU 350. The support circuits 370 are also connected to the CPU for supporting the processor. The support circuits 370 may include cache, power supplies, clock circuits, input/output circuitry, subsystems, and the like. A program (or computer instructions) readable by the controller determines which tasks are performable on the optical device substrate 101. The program may be software readable by the controller 240 and may include code to monitor, for example, the change in the percentage light loss in an optical device substrate 101 throughout the manufacturing process or the wavelength of light emitted by the light source 202.

The controller 240 is operable to facilitate the operation of the optical device metrology system 200. In some embodiments, the controller 240 includes one or more inputs (e.g., 5 inputs) for the first photodetector 212, second photodetector 214, and third photodetector 216, the fourth photodetector 218, and the fifth photodetector 220. The controller 240 is operable to select the wavelength of light that is emitted from the light source 202. In some embodiments, the controller 240 may emit a red light, a blue light, or a green light simultaneously. In some embodiments, the controller 240 may emit some combination of blue light, red light, or green light simultaneously. In some embodiments, the controller 240 may alternate between a red light, a blue light, and a green light.

The controller 240 is operable to calculate the percentage light loss of the optical device substrate 101 using a plurality of measurements. The controller 240 receives the plurality of measurements from the first photodetector 212, the second photodetector 214, the third photodetector 216, the fourth photodetector 218, and the fifth photodetector 220. The plurality of measurements includes the total power Pₜₒₜ, the reflected power P_{refl}, the transmitted power Pₜᵣₐₙₛ, and the total scattered power P_{scat}.

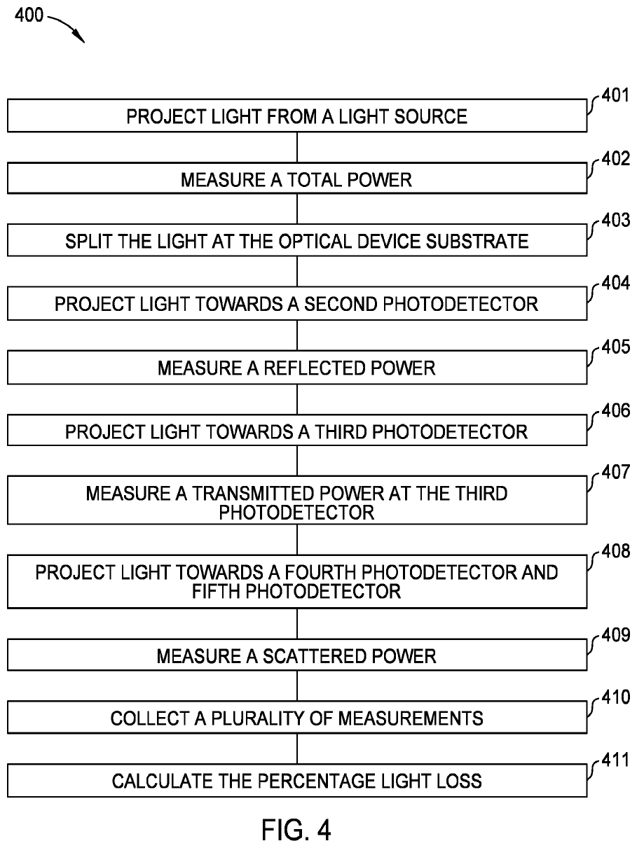

FIG. 4 is a flow diagram of a method 400 of determining the percentage light loss (e.g., optical loss) with an optical device metrology system 200. A controller 240 is operable to facilitate the operations of the method 400. At operation 401, a light is projected from a light source 202. The light is projected in a first photodetector light path 230A and an optical light path 230B. A first photodetector 212 is disposed in the first photodetector light path 230A. An optical device substrate 101 is disposed in the optical light path 230B. The light source 202 projects the light toward a first measurement position of a plurality of measurement positions on the substrate 101.

At operation 402, a total power Pₜₒₜ is measured. The total power Pₜₒₜ is measured by the first photodetector 212. The total power Pₜₒₜ is measured from the light that is projected towards the first photodetector 212 on the first photodetector light path 230A.

At operation 403, the light is split at the optical device substrate 101. The light is split into a plurality of photodetector light paths, e.g., a second photodetector light path 230C, a third photodetector light path 230D, a fourth photodetector light path 230E, and a fifth photodetector light path 230F. The optical device substrate 101 may include an optical film 104 disposed over the optical device substrate 101. The optical film 104 may be a patterned optical film. The optical device substrate 101 may include one or more optical devices 100. An optical film 104 may be disposed over the one or more optical devices 100. When the light interacts with the optical device substrate 101, a portion is absorbed within the optical device substrate 101 (e.g., a percentage light loss l), a portion is reflected (e.g., reflected power P_{refl}), a portion is transmitted (e.g., transmitted power Pₜᵣₐₙₛ), and a portion is scattered (e.g., total scattered power P_{scat}). A second photodetector 214 is disposed in the second photodetector light path 230C. A third photodetector 216 is disposed in the third photodetector light path 230D. A fourth photodetector 218 is disposed in the fourth photodetector light path 230E. A fifth photodetector 220 is disposed in the fifth photodetector light path 230F.

At operation 404, the light is projected towards a second photodetector 212. The portion of light that is reflected off the optical device substrate 101 is projected towards the second photodetector 214 on the second photodetector light path 230C. At operation 405, a reflected power P_{refl} is measured by the second photodetector 214. The second photodetector 214 is positioned at a refractive angle θ_{refract} relative to the optical light path 230B. In one embodiment, the θ_{refract} is maintained so that the optical path length inside the optical device substrate 101 stays unchanged as different types of light are emitted from the light source 202. In one embodiment, the incident angle is about 6°±0.5°, although other angles are contemplated by this disclosure.

At operation 406, the light is projected towards a third photodetector 216. The portion of light that is transmitted through the optical device substrate 101 is projected towards the third photodetector 216 on the third photodetector light path 230D. At operation 407, a transmitted power Pₜᵣₐₙₛ is measured by the third photodetector 216.

At operation 408, the light is projected towards a fourth photodetector 218 and fifth photodetector 220. A first portion of light that is scattered by the optical device substrate 101 is projected towards the fourth photodetector 218 on the fourth photodetector light path 230E. A second portion of light that is scattered by the optical device substrate 101 is projected towards the fifth photodetector 220 on the fifth photodetector light path 230F. At operation 409, a total scattered power P_{scat} is measured. The first portion of scattered power P_{scat1} is measured by the fourth photodetector 218 and the second portion of scattered power P_{scat2} is measured by the fifth photodetector 220. The total scattered power P_{scat} is measured by combining the first portion of scattered power P_{scat1} and the second portion of scattered power P_{scat2}.

Operations 401-409 are repeated at one or more of the plurality of measurement positions across the surface of the optical device substrate 101. E.g., operations 401-409 are performed at a second measurement position on the optical device substrate 101, then operations 401-409 are performed at a third measurement position on the optical device substrate 101, etc. The optical device metrology system 200 may measure up to 90 measurement positions across the surface of the optical device substrate 101, such as up to 15 measurement positions across the surface of the optical device substrate 101, such as up to 9 measurement positions across the surface of the optical device substrate 101.

At operation 410, a plurality of measurements is collected. The plurality of measurements are collected by the controller 240 from the plurality of photodetectors and from the plurality of measurement positions across the surface of the optical device substrate 101. The plurality of photodetectors includes the first photodetector 212, the second photodetector 214, the third photodetector 216, the fourth photodetector 218, and the fifth photodetector 220. The plurality of measurements comprises the total power Pₜₒₜ, the reflected power P_{refl}, the transmitted power Pₜᵣₐₙₛ, and the total scattered power P_{scat}. The total power Pₜₒₜ, reflected power P_{refl}, and transmitted power Pₜᵣₐₙₛ are measured simultaneously at the first photodetector 212, the second photodetector 214, and the third photodetector 216, respectively. The total scattered power P_{scat} is measured at the fourth photodetector 218 and fifth photodetector 220. In some embodiments, the optical loss for blue light, green light, and red light can be measured individually.

At operation 411, the percentage light loss is calculated. The controller 240 calculates the percentage light loss l at the optical device substrate 101 using the plurality of measurements. The percentage light loss l (e.g., optical loss) can be measured using equation (1):

$$l = {P}_{tot} - ( {P}_{refl} + {P}_{trans} ) \qquad ( 1 )$$

The controller 240 quantifies the percentage light loss due to scattering and absorption using the plurality of measurements. The percentage light loss due to scattering and the percentage light loss due to absorption can be measured using equation (2):

$$l = {P}_{absorbed} + {P}_{scat} \qquad ( 2 )$$

In some embodiments, the percentage light loss of the optical device substrate 101 is calculated before the optical device substrate 101 has been processed. In other embodiments, the percentage light loss of the optical device substrate 101 is calculated during the processing of the optical device substrate 101.

In still other embodiments, the percentage light loss of the optical device substrate 101 is calculated after the processing of the optical device substrate 101. In still other embodiments, the percentage light loss of the optical device substrate 101 is calculated before, during, and after processing, or some combination thereof.

The method 400 is able to give measurements to the controller 240 from the first photodetector 212, second photodetector 214, third photodetector 216, fourth photodetector 218, and fifth photodetector 220 simultaneously. This allows the controller 240 to quantify the percentage of light loss due to absorption and due to scattering. By measuring at a plurality of measurement positions across the surface of the optical device substrate 101, the controller 240 is able to calculate the average light loss across the surface of the substrate for quality control purposes. Each measurement takes less than about 1 second, leading to higher throughput, e.g., about 30 to 60 optical device substrates 101 being measured per hour.

In summation, optical device metrology systems and methods of calculating the percentage light loss of an optical device substrate or optical device are provided herein. The optical device metrology system splits an emitted light into a first photodetector light path and an optical light path. The optical device substrate splits the light into a second photodetector light path, a third photodetector light path, a fourth photodetector light path, and a fifth photodetector light path. A first photodetector is disposed in the first photodetector light path. A second photodetector is disposed in the second photodetector light path. A third photodetector is disposed in a third photodetector light path. A fourth photodetector is disposed in a fourth photodetector light path. A fifth photodetector is disposed in a fifth photodetector light path. The use of the photodetectors captures measurements of the power of the projected light at five detection points along the five separate light paths. The total power Pₜₒₜ, reflected power P_{refl}, transmitted power Pₜᵣₐₙₛ, and total scattered power P_{scat} along the five separate light paths allows for a fully-optical method of measuring percentage light loss. The optical device metrology system provides for the capture of the five powers measurements simultaneously. Measurements are also able to quantify the percentage of light lost through absorption into the optical device substrate and the percentage of light lost through scattering off the optical device substrate. The percentage light loss is calculated at a controller, which receives the measurements from the first photodetector, second photodetector, third photodetector, fourth photodetector, and fifth photodetector. The percentage light loss can be calculated before, during, or after processing the optical device substrate or optical device, enabling higher throughput.

What is claimed is:

1. An optical device metrology system, comprising:
a light source operable to emit a light into a first photodetector light path and an optical light path;
a first photodetector disposed in the first photodetector light path operable to measure a total power of the light;
a second photodetector disposed in a second photodetector light path from an optical device substrate, wherein the optical device substrate is disposed in the optical light path and operable to split the light into the second photodetector light path, a third photodetector light path, a fourth photodetector light path, and a fifth photodetector light path, the second photodetector operable to measure a reflected power of the light;
the third photodetector disposed in the third photodetector light path, the third photodetector operable to measure a transmitted power of the light;
the fourth photodetector disposed in a fourth photodetector light path, the fourth photodetector operable to measure a first portion of a scattered power of the light;
the fifth photodetector disposed in a fifth photodetector light path, the fifth photodetector operable to measure a second portion of the scattered power of the light; and
a controller, the controller operable to receive a plurality of measurements from the first photodetector, second photodetector, third photodetector, fourth photodetector, and fifth photodetector to calculate a percentage light loss within the optical device substrate.

2. The optical device metrology system of claim 1, wherein the second photodetector is positioned at an incident angle of about 5.5° to about 6.5° from the optical light path.

3. The optical device metrology system of claim 1, wherein a substrate support is operable to support the optical device substrate and operable to move the optical device substrate to one or more measurement positions.

4. The optical device metrology system of claim 3, wherein the controller is operable to receive the plurality of measurements from the one or more measurement positions.

5. The optical device metrology system of claim 1, wherein one or more additional photodetectors are operable to measure one or more additional portions of scattered power of the light.

6. The optical device metrology system of claim 1, further comprising:
a first knife edge coupled to and spaced apart from the first photodetector;
a second knife edge coupled to and spaced apart from the second photodetector; and
a third knife edge coupled to and spaced apart from the third photodetector, wherein the first knife edge, the second knife edge, and the third knife edge are operable to absorb light that reflects off of the first photodetector, the second photodetector, and the third photodetector, respectively.

7. The optical device metrology system of claim 6, wherein the first knife edge, the second knife edge, and the third knife edge are positioned at an angle of about 6° from the first photodetector, the second photodetector, and the third photodetector, respectively.

8. A method, comprising:
projecting a light from a light source toward a first photodetector in a first photodetector light path and an optical device substrate in an optical light path;
measuring a total power of the light in the first photodetector light path at the first photodetector;
projecting the light to the optical device substrate in the optical light path;
splitting the light into a second photodetector light path, a third photodetector light path, a fourth photodetector light path, and a fifth photodetector light path at the optical device substrate;
projecting the light to a second photodetector in the second photodetector light path;
measuring a reflected power of the light in the second photodetector light path at the second photodetector;
projecting the light to a third photodetector in the third photodetector light path;
measuring a transmitted power of the light in the third photodetector light path at the third photodetector;
projecting the light to a fourth photodetector in the fourth photodetector light path;
measuring a first portion of a scattered power of the light in the fourth photodetector light path at the fourth photodetector;
projecting the light to a fifth photodetector in the fifth photodetector light path;
measuring a second portion of the scattered power of the light in the fifth photodetector light path at the fifth photodetector, wherein a total scattered power is comprised of the first portion of scattered power and second portion of scattered power;
collecting a plurality of measurements from the first photodetector, second photodetector, third photodetector, fourth photodetector, and fifth photodetector at a controller, the plurality of measurements comprising the total power, the reflected power, the transmitted power, and the total scattered power; and
calculating a percentage light loss at a controller, the percentage light loss due to scattering, and the percentage light loss due to absorption at the optical device substrate using the plurality of measurements.

9. The method of claim 8, wherein the percentage light loss of the optical device substrate can be measured before a processing of the optical device substrate, during the processing of the optical device substrate, after the processing of the optical device substrate, or a combination thereof.

10. The method of claim 8, wherein a substrate support is operable to support the optical device substrate and is operable to move the optical device substrate to one or more measurement positions.

11. The method of claim 10, wherein the controller is operable to receive a plurality of measurements from the first photodetector, second photodetector, third photodetector, fourth photodetector, and fifth photodetector to calculate the percentage light loss, the percentage light loss due to scattering, and the percentage light loss due to absorption at within the optical device substrate.

12. The method of claim 11, wherein the controller is operable to receive the plurality of measurements from the one or more measurement positions.

13. The method of claim 11, wherein one or more additional photodetectors are operable to measure one or more additional portions of scattered power of the light.

14. The method of claim 11, wherein the second photodetector is positioned at an incident angle of about 5.5° to about 6.5° from the optical light path.

15. A controller of a metrology system storing instructions that, when executed by a processor, causes the metrology system to measure a percentage light loss of an optical device disposed in the metrology system, wherein the measurement of the percentage light loss comprises:
projecting a light from a light source toward a first photodetector in a first photodetector light path and an optical device substrate in an optical light path;
measuring a total power of the light in the first photodetector light path at the first photodetector;
projecting the light to the optical device substrate in the optical light path;
splitting the light into a second photodetector light path, a third photodetector light path, a fourth photodetector light path, and a fifth photodetector light path at the optical device substrate;
projecting the light to a second photodetector in the second photodetector light path;
measuring a reflected power of the light in the second photodetector light path at the second photodetector;
projecting the light to a third photodetector in the third photodetector light path;
measuring a transmitted power of the light in the third photodetector light path at the third photodetector;
projecting the light to a fourth photodetector in the fourth photodetector light path;
measuring a first portion of a scattered power of the light in the fourth photodetector light path at the fourth photodetector;
projecting the light to a fifth photodetector in the fifth photodetector light path;
measuring a second portion of the scattered power of the light in the fifth photodetector light path at the fifth photodetector, wherein a total scattered power is comprised of the first portion of scattered power and second portion of scattered power;
collecting a plurality of measurements from the first photodetector, second photodetector, third photodetector, fourth photodetector, and fifth photodetector at a controller, the plurality of measurements comprising the total power, the reflected power, the transmitted power, and the total scattered power; and
calculating a percentage light loss at a controller, the percentage light loss due to scattering, and the percentage light loss due to absorption at the optical device substrate using the plurality of measurements.

16. The controller of claim 15, wherein the percentage light loss of the optical device substrate can be measured before a processing of the optical device substrate, during the processing of the optical device substrate, after the processing of the optical device substrate, or a combination thereof.

17. The controller of claim 15, wherein a substrate support is operable to support the optical device substrate and is operable to move the optical device substrate to one or more measurement positions.

18. The controller of claim 17, wherein the controller is operable to receive a plurality of measurements from the first photodetector, second photodetector, third photodetector, fourth photodetector, and fifth photodetector to calculate the percentage light loss, the percentage light loss due to scattering, and the percentage light loss due to absorption at within the optical device substrate.

19. The controller of claim 18, wherein the controller is operable to receive the plurality of measurements from the one or more measurement positions.

20. The controller of claim 15, wherein one or more additional photodetectors are operable to measure one or more additional portions of scattered power of the light.
